(19) United States
(12) Patent Application Publication
(10) Pub. No.: US 2024/0065351 A1
(43) Pub. Date: Feb. 29, 2024

(54) FACE MASK MOUNTS FOR HEAD MOUNTED DEVICES

(71) Applicant: HEWLETT-PACKARD DEVELOPMENT COMPANY, L.P., Spring, TX (US)

(72) Inventor: Travis Shih, Taipei City (TW)

(21) Appl. No.: 17/899,705

(22) Filed: Aug. 31, 2022

(51) Int. Cl. A41D 13/11; A41F 1/00; G02B 27/01

(52) U.S. Cl. CPC A41D 13/1161; A41F 1/00; G02B 27/0176

(57) ABSTRACT

In example implementations, a head mounted device is provided. The head mounted device includes a display, a head mounting apparatus coupled to the display, and a face mask mount coupled to the head mounting apparatus. The face mask mount is to receive ear loops of a face mask to while the head mounted device is worn by the user.

### BACKGROUND

Head mounted devices may include virtual reality headsets. A virtual reality headset may include a display or augmented reality glasses that look like normal prescription glasses. Head mounted devices can be used for entertainment, education, and the like. For example, a head mounted device can be used for video games, training or instructional videos, and the like.

Recent epidemics have caused individuals to start wearing face masks. A face mask can be looped over a person's ears. The face mask can be worn while wearing a head mounted device.

### BRIEF DESCRIPTION OF THE DRAWINGS

FIG. 1 is a front view block diagram of a head mounted device with an example face mask mount of the present disclosure;

FIG. 2 is a side view block diagram of the head mounted device with an example face mask mount of the present disclosure;

FIG. 3 is a block diagram of a more detailed example of a fixed face mask mount of the present disclosure;

FIG. 4 is a block diagram of a more detailed example of an adjustable face mask mount of the present disclosure;

FIG. 5 is an isometric view of an example mechanism for the adjustable face mask mount of the present disclosure;

FIG. 6 is a cross-sectional view of the example mechanism of the present disclosure in a locked state;

FIG. 7 is a cross-sectional view of the example mechanism of the present disclosure in an unlocked state;

FIG. 8 is a cross-sectional view of another example mechanism of the present disclosure in a locked state; and

FIG. 9 is a cross-sectional view of another example mechanism of the present disclosure in an unlocked state.

### DETAILED DESCRIPTION

Examples described herein provide head mount devices with face mask mounts. As discussed above, head mounted devices may include virtual reality headsets. A virtual reality headset may include a display or augmented reality glasses that look like normal prescription glasses. Head mounted devices can be used for entertainment, education, and the like. For example, a head mounted device can be used for video games, training or instructional videos, and the like.

However, some users may want to use a face mask while using a head mounted device due to a variety of different health related reasons. Face masks have elastic ear loops that can be fitted around a user's ears. However, prolonged use of a face mask can cause discomfort or pain around the ears of the user due to tensile forces generated by the stretched ear loops.

The present disclosure provides head mounted devices that include face mask mounts that allow a user to attach the face mask to the face mask mounts instead of to the ears of the user. The tensile force of the elastic ear loops of the face mask may be applied to the face mask mounts rather than to the ears of the user. As a result, the face mask may be worn more comfortably by the user.

In addition, the face mask mounts may provide adjustability for the face mask to provide a better fit and seal around the user's nose and mouth. For example, the head mounted device may include several face mask mounts at different locations along the head mounted device for a more custom fit. In another example, the face mask mounts may be adjustable by moving the face mask mounts to provide a more custom fit.

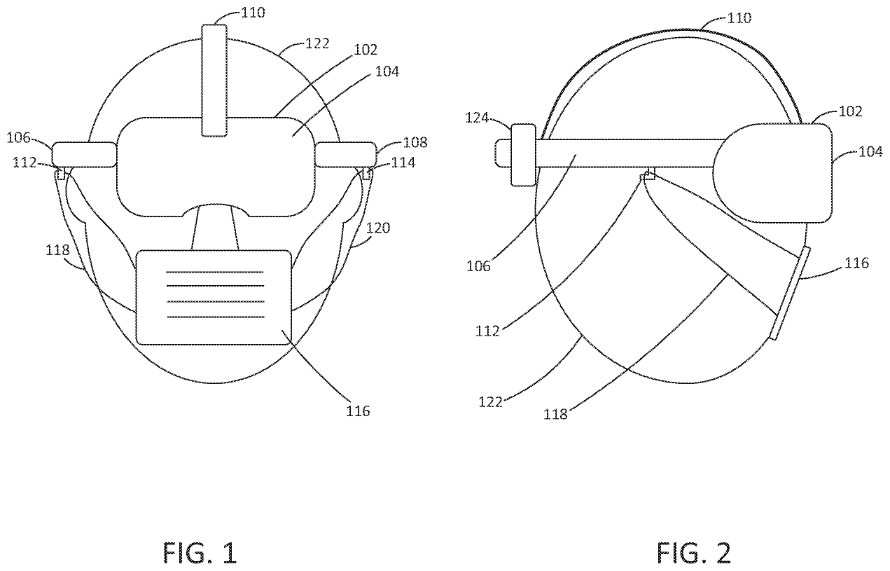

FIG. 1 illustrates a front view of an example head mounted device 102 with face mask mounts 112 and 114 of the present disclosure. FIG. 2 illustrates a side view of the example head mounted device 102 with the face mask mount 112 of the present disclosure. In an example, the head mounted device 102 may include a display 104 with a top fitting member 110 and lateral fitting members 106 and 108. The display 104 may provide graphical content that is consumed by a user 122. The display 104 may be a video display in the case of a virtual reality (VR) head set or may be optically clear glass that can display additional graphics or video in the case of an augmented reality (AR) head set.

The top fitting member 110 and the lateral fitting members 106 and 108 may be straps that are connected to the display 104 and used to fit a head of the user 122. FIG. 2 illustrates an adjustable connector 124 that is coupled to the top fitting member 110 and the lateral fitting members 106. The adjustable connector 124 may be rotated to tighten or loosen the top fitting member 110 and the lateral fitting members 106 to customize the fit of the head mounted device 102 to the head of a user 122.

It should be noted that the head mounted device 102 has been simplified for ease of explanation and may include additional components that are not shown. For example, the head mounted device 102 may include a processor, a memory, a power supply, a graphics processor, connection interfaces (e.g., a universal serial bus (USB) interface), a microphone, control interfaces (e.g., joysticks or gloves communicatively coupled to the head mounted device 102), and the like.

Referring back to FIG. 1, the head mounted device 102 may include the face mask mounts 112 and 114. In an example, the face mask mount 112 may be coupled to the lateral fitting member 106 and the face mask mount 114 may be coupled to the lateral fitting member 108. In other words, the face mask mounts 112 and 114 may be located on both sides of the head mounted device 102.

A face mask 116 may be worn by the user 122 while wearing the head mounted device 102 by coupling ear loops 118 and 120 of the face mask 116 to the face mask mounts 112 and 114, respectively. For example, as shown in FIG. 2, the face mask mount 112 may be a hook. The face mask mounts 112 and 114 may have a variety of different shapes, such as an “L” shape, a “J” shape, a “U” shape, and the like. FIG. 2 illustrates an example of the face mask mount 112 deployed as an “L” shaped hook.

The ear loop 118 may be coupled to the face mask mount 112 and the ear loop 120 may be coupled to the face mask mount 114. Thus, the face mask mounts 112 and 114 may absorb the tensile force generated by the elastic ear loops 118 and 120 rather than the ears of the user 122. As a result, the user 122 may wear the face mask 116 more comfortably while using the head mounted device 102 and may wear the face mask 116 for a longer duration.

Although FIGS. 1 and 2 illustrate the face mask mounts 112 and 114 as each comprising a single hook in a fixed location along the lateral fitting members 106 and 108, the face mask mounts 112 and 114 may be deployed on different locations on the head mounted device 102. In addition, a plurality of the face mask mounts 112 and 114 may also be deployed to provide adjustability of the fit of the face mask 116, or the face mask mounts 112 and 114 may be mechanically movable along the lateral fitting members 106 and 108.

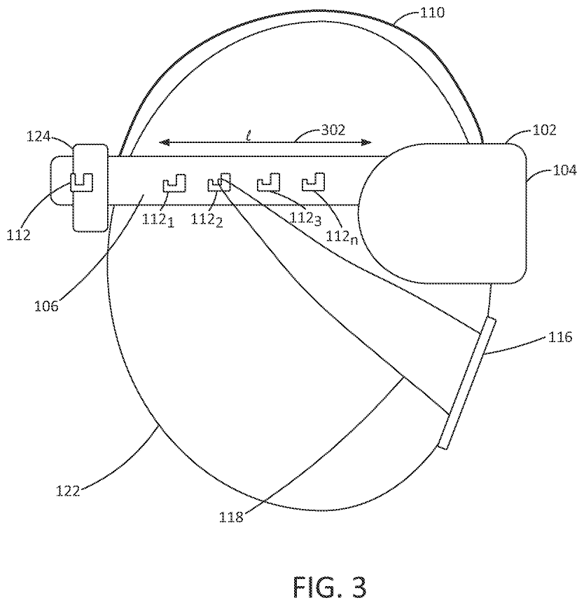

FIG. 3 illustrates a side view of an example of the head mounted device 102 with a plurality of face mask mounts 112 and 114. FIG. 3 illustrates a view that shows the lateral fitting member 106 and a plurality of face mask mounts 112₁ to 112ₙ (hereinafter also referred to individually as a face mask mount 112 or collectively as face mask mounts 112). However, it should be noted that the opposite side (not shown) that includes the lateral fitting member 108 may also have a plurality of face mask mounts 114 deployed identically to the plurality of face mask mounts 112, as described below.

FIG. 3 illustrates an example of the face mask mounts 112 deployed as a “J” shaped hook. In an example, the face mask mounts 112 may be distributed or positioned laterally along the lateral fitting member 106. Said another way, the face mask mounts 112 may be spaced apart along a length 302 of the lateral fitting member 106. The face mask mounts 112 may be evenly spaced along the length 302 of the lateral fitting member 106, or some of the face mask mounts 112 may be unevenly spaced apart. The plurality of face mask mounts 114 on the lateral fitting member 108 on the opposite side of the head of the user 122 (not shown) may be positioned or spaced apart the same as the face mask mounts 112.

As a result, the user 122 may position the ear loop 118 on a desired face mask mount 112 for a custom fit. For example, the ear loop 118 may be positioned closer to the face mask mount 112₁ for a tighter fit or may be positioned closer to the face mask mount 112ₙ for a looser fit. Thus, the deployment of the plurality face mask mounts 112 and 114 may allow the user 122 to adjust the fit of the face mask 116.

In an example, the face mask mounts 112 may be positioned on the adjustable connector 124 in addition to, or rather than, on the lateral fitting members 106 and 108. For example, the face mask mounts 112 and 114 may be positioned on opposite sides of the adjustable connecter 124.

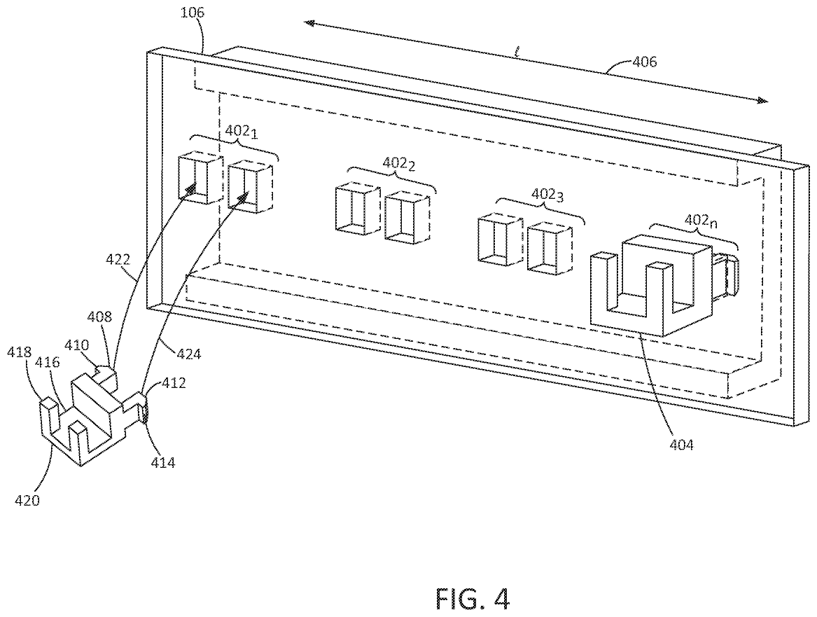

FIG. 4 illustrates a detailed view of another example face mask mount 112 and 114 that can be deployed on the lateral fitting member 106 and 108. In an example, the face mask mount may include a single hook 404 that can be moved to different positions along a length 406 of the lateral fitting member 106 via pairs of openings 402₁ to 402ₙ (hereinafter also referred to individually as a pair of openings 402 or collectively as pairs of openings 402).

In an example, the hook 404 may have a “U” shape. The hook 404 may be generally a cubic shape with an open volume 416. The hook 404 may include post members 418 and 420. The ear loop 118 or 120 may be attached to the hook 404 around the post member 418, around the post member 420, or around both post members 418 and 420 and inside the open volume 416.

In an example, the hook 404 may include a connection member 408 and a connection member 412. The connection member 408 may have a lip 410 and the connection member 414 may have a lip 414. The connection members 408 and 412 may be inserted into a desired pair of openings 402 to position the hook 404 at a desired location along the length 406 of the lateral fitting member 106.

The hook 404 may be secured in the pair of openings 402 via the lips 410 and 414 that extend against a back surface of the pair of openings 402. The hook 404 may be removed from the pair of openings 402 by applying a force against the connection members 408 and 412 towards one another. In other words, the connection members 408 and 412 may be “squeezed” together to clear the lips 410 and 414 from the back surface of the pair of openings 402. The hook 404 may then be removed and moved to another pair of openings 402 along the length 406 of the lateral fitting member 106.

In another example, the face mask mounts 112 and 114 may be mechanically movable. For example, the face mask mounts 112 and 114 may be slidable or movable within the lateral fitting members 106 and 108 to a desired position.

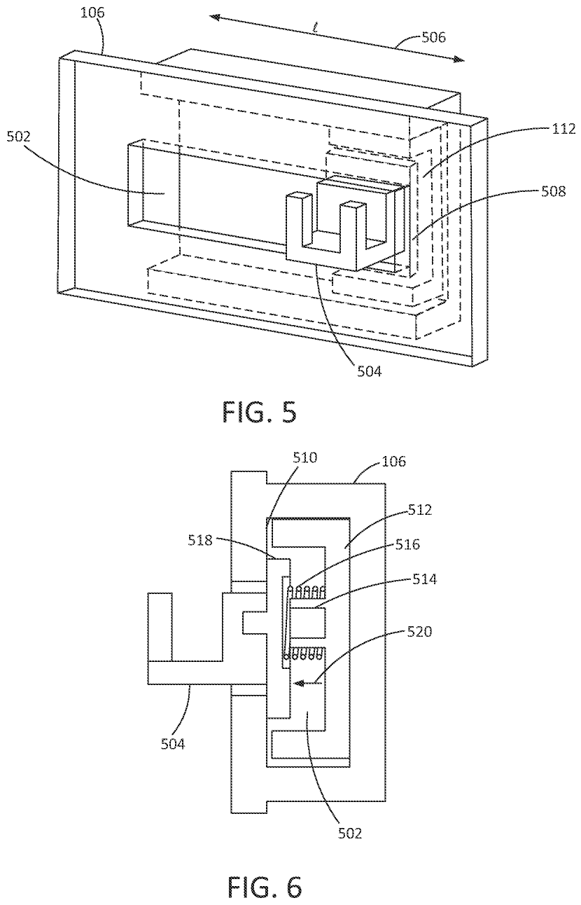

FIGS. 5-9 illustrate examples of a face mask mount 112 that is mechanically movable. FIGS. 5-9 illustrate examples of the face mask mount 112 that is mechanically movable along the lateral fitting member 106. However, it should be noted that a mechanically movable face mask mount 114 in the lateral fitting member 108 may be identical to the mechanically movable face mask mount 112.

FIG. 5 illustrate an isometric view of the lateral fitting member 106 with a mechanically movable face mask mount 112. In an example, the lateral fitting member 106 may include a track 502. The track 502 may be an open volume inside of the lateral fitting member 106 that is shaped to retain and guide movement of the face mask mount 112 within the track 502. The face mask mount 112 may be movable along a length 506 of the lateral fitting member 106.

In an example, the mechanically movable face mask mount 112 may be an assembly of various components. For example, the face mask mount 112 may include a locking mechanism 508 and a hook 504. The locking mechanism 508 may lock or arrest movement of the friction plate (discussed below), which locks or arrests movement of the face mask mount 112 in a desired location along the track 502 and/or releases the face mask mount 112 to allow movement of the face mask mount 112 along the track 502.

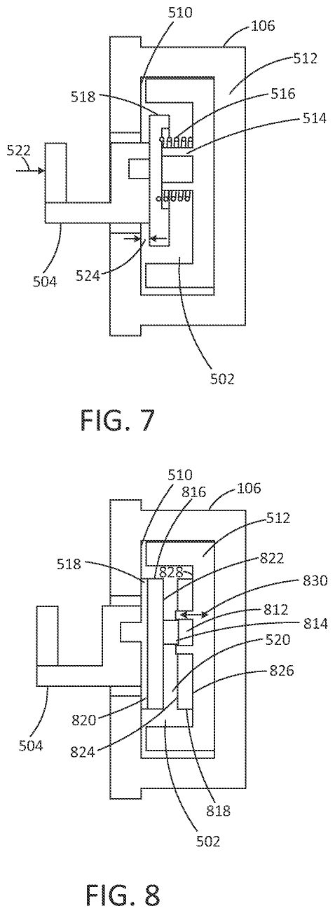

FIGS. 6 and 7 illustrate a cross-sectional side view of a first example of the mechanically movable face mask mount 112. FIG. 6 illustrates the face mask mount 112 in a locked position and FIG. 7 illustrates the face mask mount 112 in an unlocked position.

In an example, the mechanically movable face mask mount 112 may include a movable friction plate 518, a mounting member 512, and a compression spring 516. The mounting member 512 may be a spring holding. The compression spring 516 may be coupled to the friction plate 518 and the mounting member 512. The compression spring 516 may be located between the friction plate 518 and the mounting member 512. The hook 504 may be coupled to a first side of the friction plate 518 and the compression spring 516 may be coupled to a second side of the friction plate 518 that is opposite the first side of the friction plate 518.

In an example, a compression member 514 may be coupled to the mounting member 512. The compression spring 516 may be coiled around the compression member 514 to provide more structural support for the compression spring 516. For example, the compression member 514 may control movement of the compression spring 516 to move along a direction shown by an arrow 520 and to prevent the compression spring 516 from being bent in a direction off axis of the arrow 520.

In an example, the mounting member 512 may be shaped to be similar to a shape of the track 502. As a result, the mounting member 512 may be secured by the track 502, and movement of the mounting member 512 may be guided by the track 502 along the length 506 of the lateral fitting member 106.

In an example, the compression spring 516 may provide a force that urges the friction plate 518 against an inner side 510 of the track 502 in a direction shown by the arrow 520. The friction plate 518 may include an abrasion, a series of grooves, a plurality of protrusions, a rubber surface, and the like, that prohibits movement of the hook 504 and the mounting member 512 when the friction plate 518 is urged against, or engaged against, the inner side 510 of the track 502.

FIG. 7 illustrates a cross-sectional view of the mechanically movable face mask mount 112 when the locking mechanism 508 is in an unlocked position. For example, the user 122 may apply a force or press against the hook 504 in a direction as shown by an arrow 522. The force may be applied against the compression spring 516 to cause the compression spring 516 to compress. As a result, the friction plate 518 may move away from the inner side 510. In other words, the force against the hook 504 may cause the friction plate 518 to no longer contact or urge against the inner side 510.

With the friction plate 518 moved away from the inner side 510, the locking mechanism 508 may be moved to an unlocked position. In other words a gap 524 may be formed between the friction plate 518 and the inner side 510 as shown in FIG. 7.

In the unlocked position, the hook 504, the friction plate 518, and the mounting member 512 may be freely moved along the track 502 into a desired position. With the desired position selected, the user may release or remove the force against the hook 504. As a result, the compression spring 516 may be restored to a default position and may apply a force against the friction plate 518 towards the inner side 510. The spring force of the compression spring 516 may urge the friction plate 518 against the inner side 510 at the selected location along the track 502 to re-lock the locking mechanism 508.

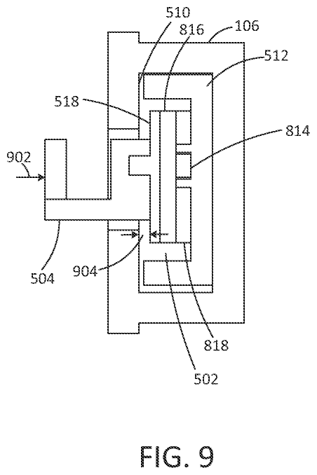

FIGS. 8 and 9 illustrate a cross-sectional side view of a second example of the mechanically movable face mask mount 112. FIG. 8 illustrates the face mask mount 112 in a locked position. FIG. 9 illustrates the face mask mount 112 in an unlocked position.

In an example, the mechanically movable face mask mount 112 may include the movable friction plate 518, the mounting member 512, and a magnetic system to act as the locking mechanism 508. In an example, the magnetic system may include a first magnet 816 and a second magnet 818.

The mounting member 512 may be a magnet holder member to hold the first magnet 816 and the second magnet 818. For example, the mounting member 512 may include a hollow cylinder member 812. The first magnet 816 may be coupled to a cylindrical member 814 that is movably coupled to the hollow cylinder member 812. The second magnet 818 may be coupled to the hollow cylinder member 812. For example, the second magnet 818 may be shaped like a doughnut or have a center opening where the hollow cylinder member 812 may be fitted through such that the second magnet 818 is positioned around the hollow cylindrical member 812. The second magnet 818 may rest against, or be coupled to, the mounting member 512 and positioned around the hollow cylindrical member 812.

As described above, the friction plate 518 may include an abrasion, a series of grooves, a plurality of protrusions, a rubber surface, and the like. The surface of the friction plate 518 may prohibit movement of the hook 504 and the mounting member 512 when the friction plate 518 is urged, or engaged, against the inner side 510 of the track 502.

In an example, the first magnet 816 and the second magnet 818 may be arranged such that polarity of the first magnet 816 and the polarity of the second magnet 818 repel each other. As a result, the first magnet 816 may be urged away from the second magnet 818 and cause the friction plate 518 to be pressed against, or engaged against, the inner side 510 of the track 502.

To illustrate, the first magnet 816 may have a first side 820 and a second side 822. The second magnet 818 may have a first side 824 and a second side 826. The first side 820 and the second side 822 may have opposite polarities. For example, the first side 820 may be positive and the second side 822 may be negative or vice versa.

Similarly, the first side 824 and the second side 826 may have opposite polarities. For example, the first side 824 may be positive and the second side 826 may be negative or vice versa.

In an example, the first magnet 816 and the second magnet 818 may be arranged such that the second side 822 of the first magnet 816 faces the first side 824 of the second magnet 818. In addition, the second side 822 and the first side 824 may have the same polarity to cause the first magnet 816 to be repelled away from the second magnet 818. For example, the second side 822 of the first magnet 816 and the first side 824 of second magnet 818 may have the same polarity. In other words, if the second side 822 has a positive polarity, then the first side 824 would also have a positive polarity. Alternatively, if the second side 822 has a negative polarity, then the first side 824 would also have a negative polarity.

To move the hook 504, the locking mechanism 508 may be unlocked by applying a force against the hook 504 in a direction shown by an arrow 902 illustrated in FIG. 9. The force may be greater than the repelling force caused by the same polarity of the second side 822 of the first magnet 816 and the first side 824 of the second magnet 818.

As a result, the cylindrical member 812 coupled to the second side 822 of the first magnet 816 may be moved further into the hollow cylinder member 812. In other words, the first magnet 816 may be pushed closer to the second magnet 818. The force may also move the friction plate 518 away from the inner side 510 to create a gap 904 between the friction plate 518 and the inner side 510. Thus, the friction plate 518 no longer contacts the inner side 510 and the locking mechanism 508 is in an unlocked position.

In the unlocked position, the hook 504, the friction plate 518, and the mounting member 512 may be freely moved along the track 502 into a desired position. With the desired position selected, the user may release or remove the force against the hook 504. As a result, the repelling force caused by the same polarity of the second side 822 and the first side 824 facing each other may cause the first magnet 816 to move away from the second magnet 818. The first magnet 816 may apply a force against the friction plate 518 towards the inner side 510 to re-lock the locking mechanism 508.

Thus, the user 122 may adjust the mechanically movable face mask mount 112 to a desired position and achieve a desired fit of the face mask 116 against the face of the user 122. The user 122 may wear the face mask 116 more comfortably and for longer periods of time while using the head mounted device 102 due to the tensile force of the ear loops 118 and 120 being absorbed by the face mask mounts 112 and 114 and not by the ears of the user 122.

Although various example designs of the mechanically movable face mask mounts 112 and 114 are illustrated in FIGS. 4-9 and discussed above, it should be noted that other designs may be deployed. For example, the hook 504 may be mounted on a track with pre-defined positions. The hook 504 may then be moved into a desired position by movement along the track. In another example, the hook 504 may be moved and held into position by a small motor, and so forth.

As noted above, although FIGS. 4-9 illustrate a single lateral side (e.g., the lateral fitting member 106) of the head mounted device 102, it should be noted that the face mask mounts 114 on the opposite side (e.g., the lateral fitting member 108) may be designed the same as the face mask mounts 112 illustrated in FIGS. 4-9. In other words, if the example face mask mount 112 illustrated in FIG. 4 is deployed, the face mask mounts 114 on the lateral fitting member 108 may be the same. In another example, if the example mechanically movable face mask mount 112 illustrated in FIGS. 6 and 7 or FIGS. 8 and 9 are deployed, then the face mask mounts 114 on the lateral fitting member 108 may be the same. In other words, the face mask mounts 112 and 114 may be deployed with the same hook shape and features on both sides of the head mounted device 102.

Also, as discussed above, the figures appear to illustrate a VR head set. However, it should be noted that the face mask mounts 112 and 114 may also be deployed in AR glasses. For example, the arms of the AR glasses that rest on the ears of the user 122 may include the various examples of the face mask mounts 112 and 114.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A head mounted device, comprising:
a display;
a head mounting apparatus coupled to the display; and
a face mask mount coupled to the head mounting apparatus to receive ear loops of a face mask while the head mounted device is worn by a user.

2. The head mounted device of claim 1, wherein the face mask mount comprises a plurality of fixed hooks.

3. The head mounted device of claim 2, wherein the head mounting apparatus comprises:
a first lateral fitting member; and
a second lateral fitting member opposite the first lateral fitting member, wherein the plurality of fixed hooks is coupled to first lateral fitting member and the second lateral fitting member.

4. The head mounted device of claim 3, wherein a first subset of the plurality of fixed hooks is arranged along a length of the first lateral fitting member.

5. The head mounted device of claim 4, wherein a second subset of the plurality of fixed hooks is arranged along a length of the second lateral fitting member.

6. The head mounted device of claim 2, wherein the head mounting apparatus comprises an adjustable connector, wherein the plurality of fixed hooks is coupled to opposite sides of the adjustable connector.

7. The head mounted device of claim 3, wherein at least one hook of the plurality of fixed hooks is coupled to the first lateral fitting member, and at least one hook of the plurality of fixed hooks is coupled to the second lateral fitting, and wherein the at least one hook coupled to the first lateral fitting member and the at least one hook coupled to the second lateral fitting member each have an “L” shape, a “J” shape, or a “U” shape.

8. The head mounted device of claim 1, wherein the face mask mount comprises a movable hook to adjust a tension of the face mask.

9. The head mounted device of claim 8, wherein the head mounting apparatus comprises:
a first lateral fitting member that includes a first movable hook to move along a length of the first lateral fitting member; and
a second lateral fitting member that includes a second movable hook to move along a length of the second lateral fitting member.

10. The head mounted device of claim 9, wherein the first movable hook is movable via a first plurality of openings located along a length of the first lateral fitting member and the second movable hook is movable via a second plurality of openings located along a length of the second lateral fitting member.

11. The head mounted device of claim 9, wherein the first movable hook is movably coupled to the first lateral fitting member to slide along the length of the first lateral fitting member and the second movable hook is movably coupled to the second lateral fitting member to slide along the length of the second lateral fitting member.

12. A head mounted device, comprising:
a display;
a head mounting apparatus coupled to the display, wherein the head mounting apparatus comprises a first lateral side and a second lateral side;
a first mechanically movable face mask mount coupled to the first lateral side of the head mounting apparatus to receive a first loop of a face mask; and
a second mechanically movable face mask mount coupled to the second lateral side of the head mounting apparatus to receive a second loop of the face mask.

13. The head mounted device of claim 12, wherein the first mechanically movable face mask mount and the second mechanically movable face mask mount each comprise:
a track;
a friction plate movably coupled to the track; and
a locking mechanism.

14. The head mounted device of claim 13, wherein the locking mechanism arrests movement of the friction plate along the track when the locking mechanism is engaged.

15. The head mounted device of claim 13, wherein the locking mechanism comprises:
a spring holder member to move along the track; and
a compression spring coupled to the spring holder member between the friction plate and the spring holder member.

16. The head mounted device of claim 13, wherein the locking mechanism comprises:
a magnet holder member to move along the track, wherein the magnet holder member comprises a hollow cylindrical member;
a first magnet coupled to a cylindrical member that is movably coupled to the hollow cylindrical member;
a second magnet positioned around the hollow cylindrical member and coupled to the magnet holder member; and
the friction plate coupled to the first magnet.

17. The head mounted device of claim 16, wherein a second side of the first magnet faces a first side of the second magnet and a polarity of the second side of the first magnet is a same polarity as the first side of the second magnet.

18. A head mounted device, comprising:
a display;
a head mounting apparatus coupled to the display, wherein the head mounting apparatus comprises:
a first lateral fitting member with a first interior volume along a length of the first lateral fitting member, wherein the first interior volume comprises a first movable friction plate with a first locking mechanism;
and a second lateral fitting member with a second interior volume along a length of the second lateral fitting member, wherein the first interior volume comprises a second movable friction plate with a second locking mechanism;
a first face mask mount coupled to the first friction plate to receive a first loop of a face mask; and
a second face mask mount coupled to the second friction plate to receive a second loop of the face mask

19. The head mounting device of claim 18, wherein the first locking mechanism comprises a first compression spring to provide a force to cause the first movable friction plate to engage against an interior surface of the first interior volume and the second locking mechanism comprises a second compression spring to provide a force to cause the second movable friction plate to engage against an interior surface of the second interior volume.

20. The head mounting device of claim 18, wherein the first locking mechanism comprises a first magnetic system to provide a force to cause the first movable friction plate to engage against an interior surface of the first interior volume and the second locking mechanism comprises a second magnetic system to provide a force to cause the second movable friction plate to engage against an interior surface of the second interior volume.
